(19) United States
(12) Patent Application Publication
(10) Pub. No.: US 2015/0108304 A1
(43) Pub. Date: Apr. 23, 2015

(54) WALL HANGER

(71) Applicant: William Harold LARSEN ROLDAN, San Juan, PR (US)

(72) Inventor: William Harold LARSEN ROLDAN, San Juan, PR (US)

(21) Appl. No.: 14/056,158

(22) Filed: Oct. 17, 2013

(51) Int. Cl. F16M 13/02

(52) U.S. Cl. CPC F16M 13/02
USPC 248/216.1; 29/432

(57) ABSTRACT

A wall hanger device and method for installing a wall hanger device. In one exemplary embodiment at least a first hanger body having at least a first lower hanging element; at least a first fastening element that is a first needle having at least a head, a shaft, and a point; the shaft having at least a middle portion and a front end; the first hanger body having at least a first bore that has cross sectional dimensions complementary to the middle portion; the first hanger body and the first fastening element being an autonomous assembly made of molded plastic, and the shaft that is forcibly detachable from an outer end of the first bore when an external force is exerted on an outer face of the head while a back of the hanger body is positioned adjacent to a hanging surface, which then allows the middle portion of the first needle to slideably and frictionally enter the first bore until an under face of the head is adjacent to a portion of a front of the hanger body, and the point and the front end to puncture, then enter into, the hanging surface.

### BACKGROUND

Wall hanging devices are used to suspend objects from hanging surfaces, such as walls. Presently, wall hangers marketed for their weight bearing capacity are often so large that their presence detracts from the appearance of the hanging surface and the object hanging from the wall hanger. A high weight bearing wall hanger also often requires that it is fastened to a stud behind the hanging surface in order to support large loads, which limits positioning possibilities. Further, currently available wall hangers generally require the use of unsightly fastening elements, such as screws or nails, which can excessively damage the hanging surface and require the use of large, unwieldy tools, such as drills.

Some existing wall hangers are discrete in size, but do not provide adequate load carrying ability. Additionally, discrete wall hangers that are currently on the market are tedious to fasten to the wall because their small size. It is difficult for an individual to hold the wall hanger and separate fastening element together in place, at the right angle, and in the right position on the hanging surface while exerting the force required to fasten the wall hanger to the hanging surface. Injury and inefficiency is a likely result when trying to fasten presently available wall hangers.

### SUMMARY

A wall hanger device and method for installing a wall hanger device. In one exemplary embodiment at least a first hanger body having at least a first lower hanging element; at least a first fastening element that is a first needle having at least a head, a shaft, and a point; the shaft having at least a middle portion and a front end; the first hanger body having at least a first bore that has cross sectional dimensions complementary to the middle portion; the first hanger body and the first fastening element being an autonomous assembly made of molded plastic, and the shaft that is forcibly detachable from an outer end of the first bore when an external force is exerted on an outer face of the head while a back of the hanger body is positioned adjacent to a hanging surface, which then allows the middle portion of the first needle to slideably and frictionally enter the first bore until an under face of the head is adjacent to a portion of a front of the hanger body, and the point and the front end to puncture, then enter into, the hanging surface.

### BRIEF DESCRIPTION OF THE FIGURES

FIG. 1a is an exemplary side view of a wall hanger before an external force detaches the needle from the body and the needle enters into a hanging surface.

FIG. 1b is an exemplary side view of a wall hanger after an external force detaches the needle from the body and the needle enters into a hanging surface.

FIG. 1c is an exemplary isometric view of the front of a first exemplary embodiment of a wall hanger.

FIG. 2a is an exemplary side view of a wall hanger before an external force detaches the needle from the hanger body and the needle enters into a hanging surface.

FIG. 2b is an exemplary side view of a wall hanger after an external force detaches the needle from the hanger body and the needle enters into a hanging surface.

FIG. 3a is an exemplary front isometric view of a wall hanger before an external force detaches a first needle and a second needle from the hanger body, and the first needle and the second needle enter into a hanging surface.

FIG. 3b is an exemplary side view of a wall hanger before an external force detaches a first needle and a second needle from the hanger body, and the first needle and the second needle enter into a hanging surface.

FIG. 4a is an exemplary front isometric view of a wall hanger before an external force detaches a first needle and a second needle from the hanger body, and the first needle and the second needle enter into a hanging surface.

FIG. 4b is an exemplary side view of a wall hanger before an external force detaches a first needle and a second needle from the hanger body, and the first needle and the second needle enter into a hanging surface.

FIG. 5a is an exemplary top isometric view of a wall hanger before an external force exerted on the front of the hanger body pounds a first needle into a hanging surface.

FIG. 5b is an exemplary side-back isometric view of a wall hanger before an external force exerted on the front of the hanger body pounds a first needle into a hanging surface.

FIG. 5c is an exemplary side view of a wall hanger after an external force exerted on the front of the hanger body pounds a first needle into a hanging surface.

FIG. 6 is an exemplary front isometric view of a wall hanger before an external force detaches a first needle and a second needle from the body, and the first needle and the second needle enter into a hanging surface.

### DETAILED DESCRIPTION

Aspects of the present invention are disclosed in the following description and related figures directed to specific embodiments of the invention. Those skilled in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention,” “embodiments,” or “invention” do not require that all embodiments of the invention include the discussed feature, advantage or mode of operation.

Generally referring to the accompanying drawings, a wall hanger may be formed in any of a variety of manners and may be used in any of a variety of situations. An exemplary embodiment may be a wall hanger assembly, although other forms and designs are envisioned. An exemplary situation where the device might be used is in a home, office, restaurant, bar, and other private and public places. Another exemplary situation where the device may be used is where a discrete wall hanging element is desired. Further, another exemplary situation where the device may be used is where an object of significant mass must be hung on a hanging surface, such as a drywall, sheetrock, or gypsum surface. Still another exemplary situation where the device may be used is where an object must be hung on any point of a hanging surface without locating a stud behind the hanging surface. Additionally, another situation where the device may be used is where it is desired to hang an object on a hanging surface, such as a drywall, sheetrock, or gypsum surface, without the use of drills to reduce damage to the hanging surface.

Still generally referring to the accompanying drawings, a wall hanger may be an autonomous assembly that includes a hanger body and a fastening element. The fastener element, for example a nail or needle, may detach from the hanger body once the wall hanger is nailed to the hanging surface by, for example, hammering. This can allow for the positioning of the wall hanger in a desired location on the hanging surface by holding the hanger body or a lower hanging element of the wall hanger between their fingers while safely nailing the fastener element into the wall with their fingers out of harms way. Reduced risk of injury can also allow for more wall hangers to be installed at a faster rate. Additionally, the fastener element may have fins that increase the contact surface area between the fastening element and the holding area of the wall. Once nailed in place, the fastener element can secure the hanger body against the hanging surface such that the back of the hanger body is adjacent to the hanging surface. The substantial surface area of the back of the hanger body that can be disposed against the hanging surface allows the wall hanger to hang high-mass objects.

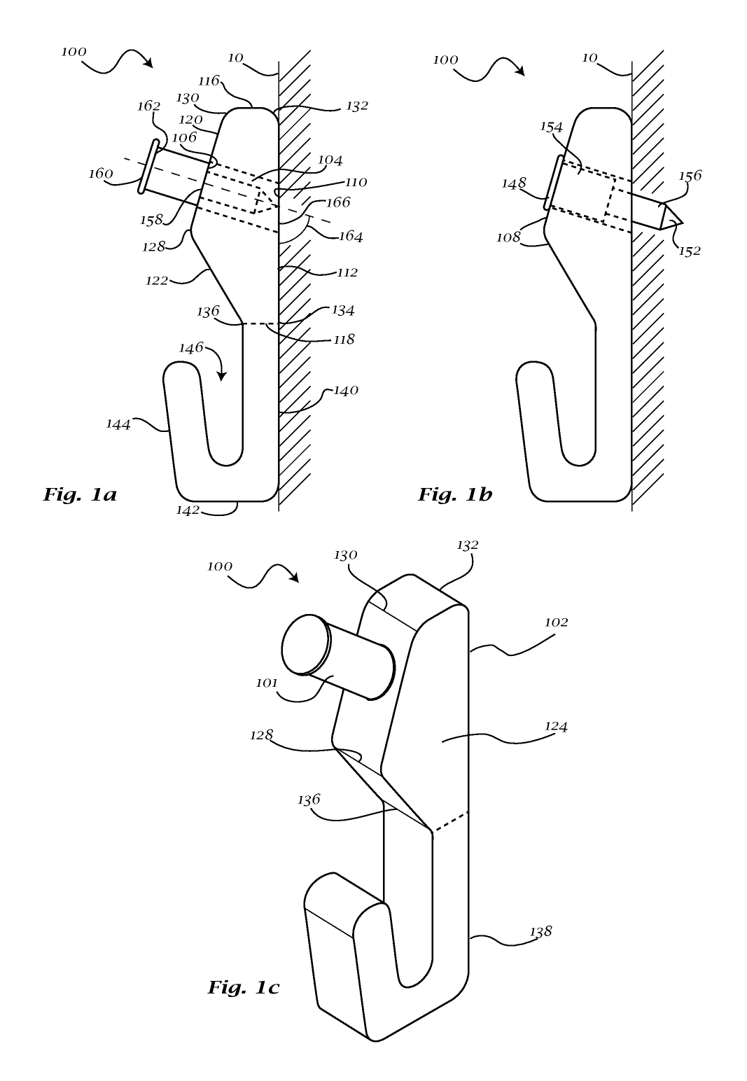

Referring now to exemplary FIGS. 1a-c, views of the wall hanger assembly 100 may be shown. FIG. 1a may show a side view of wall hook 100 before an external force detaches a needle 101 from a body 102 and the needle 101 enters into a hanging surface. FIG. 1b may show a side view of a wall hook 100 after an external force detaches the needle 101 from the body 102 and the needle 101 enters into a hanging surface. FIG. 1c may show a front isometric view of wall hook 100 before an external force detaches the needle 101 from the body 102 and the needle 101 enters into a hanging surface.

As shown in exemplary FIGS. 1a-c, the wall hanger assembly 100 may include at least a first hanger body 102 with at least a first bore 104. The first bore 104 can extend from an outer end 106 at a front 108 of the hanger body 102 through the hanger body 102, to an open inner end 110 at a back 112 of the hanger body. The first bore 104 may have cross sectional dimensions complementary to a middle portion of the fastening element, which may be a needle 101. Both the hanger body 102 and the needle 101 may be made of molded plastic. Additionally, the hanger body 102 and the needle 101 may be the same color. The color of the wall hanger may be adjusted to match the color of the hanging surface to which the wall hanger is to be fastened. Matching colors may enable the wall hanger to less noticeable so as to not distract from the appearance of the hanging surface or object being supported by the wall hanger.

Still referring to exemplary FIGS. 1a-c, the first hanger body 102 may be substantially prism-shaped, for example substantially irregular pentagonal prism-shaped, such that the first hanger body 102 can include a top 116, the back 112, a bottom 118, the front 108 having an upper face 120 and a lower face 122, and left and right sides 124. In this exemplary embodiment, the first hanger body 102 may also include edges, for example a front edge 128, a front-top edge 130, a back-top edge 132, a back-bottom edge 134, and a front-bottom edge 136. The edges 128, 130, and 132 may be rounded.

Further referring to exemplary FIGS. 1a-c, the hanger body 102 may have a lower hanging element, such as a hook 138. The wall hanger assembly 100 may be molded such that the hook 138 extends from the bottom 118. A shank 140 of the hook 138 can seamlessly extend from the back 112 such that the surface area of the hanger body 102 disposed against the hanging surface 10 is maximized. This allows the wall hanger assembly 100 to hang high-mass objects. When the hanger body 102 is nailed to a hanging surface 10, the shank 140, a bend 142, and a throat 144 of the hook 138 can define a channel 146 for receiving any hanging element, for example a wire or loop, that may be used to suspend an object being supported by the wall hanger assembly 100 in its desired location.

Still referring to exemplary FIGS. 1a-c, an exemplary embodiment of the fastener element, needle 101, may be shown as a part of an exemplary embodiment of the wall hanger assembly 100. Needle 101 may include a head 148, a shaft, and a point 152. The shaft may include a middle portion 154 and a front end 156. The length of the middle portion 154 and front end 156 can vary. The wall hanger assembly 100 may be molded such that a bottom outer edge 158 of the middle portion 154 of shaft is joined to the outer end 106 of the bore 104. The bottom outer edge 158 and outer end 106 may be joined such that when an external force, such as a hammering force, is exerted onto a outer face 160 of the head 148 while the back 112 is held adjacent to the hanging surface 10, the bottom outer edge 158 detaches from the outer end 106 allowing the middle portion 154 of the needle 101 to slideably and frictionally enter the bore 104 until an under face 162 of the head 144 is adjacent to a portion of the upper face 120 of the front 108 that surrounds the outer end 106, and the point 148 and front end 152 of the shaft to puncture then enter into the hanging surface 10.

As shown in exemplary FIG. 1a, an entering angle 164 between a lengthwise plane 166 of the bore 104 and the hanging surface 10 when the needle 101 is nailed into the hanging surface 101 may be acute, for example the entering angle 164 may be about 60 degrees or about 45 degrees. In some embodiments, the first bore 104 may be angled through the hanger body 102 such that the lengthwise plane 166 of the bore 104 is perpendicular to the upper face 120 of the front 108.

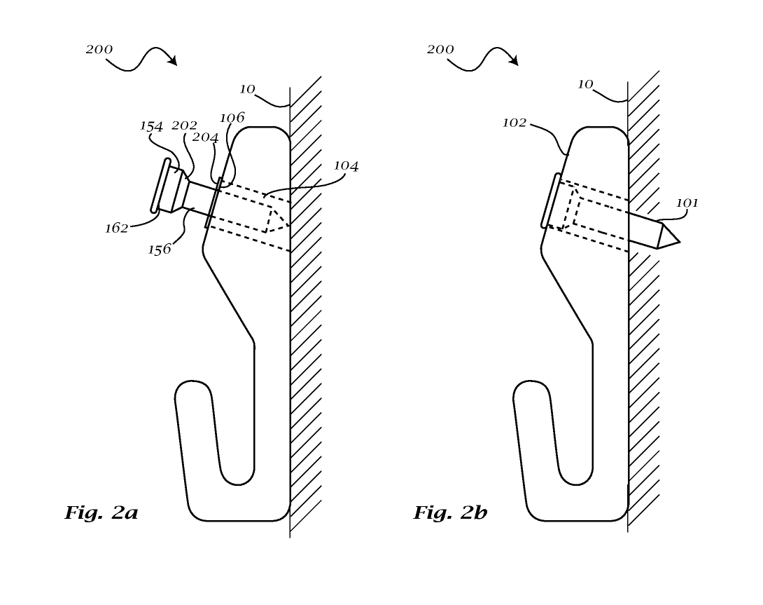

Referring now to exemplary FIGS. 2a and 2b, views of an exemplary embodiment of a wall hanger assembly 200 may be shown. FIG. 2a may show a side view of wall hook 200 before an external force detaches needle 101 from body 102 and the needle 101 enters into a hanging surface. FIG. 2b may show a side view of a wall hook 200 after an external force detaches the needle 101 from the body 102 and the needle 101 enters into a hanging surface. The shaft of the needle 101 may include a tapered portion 202 between the middle portion 154 and front end 156. The length of the tapered portion 202 can vary. Also in this exemplary embodiment, the wall hanger assembly 200 may be molded such that the front end 156 of shaft is joined to the outer end 106 of the bore 104 by a thin joining layer 204. The front end 156 and outer end 106 may be joined such that when an external force, such as a hammering force, is exerted onto the outer face 160 of the head 148 while the back 112 is held adjacent to the hanging surface 10, the front end 156 detaches from the outer end 106 allowing the tapered portion 202 and middle 150 of the needle 101 to slideably and frictionally enter the bore 104 until the under face 162 of the head 148 is adjacent to a portion of the upper face 120 of the front 108 that surrounds the outer end 106, and the point 152 and front end 156 of the shaft to puncture then enter into the hanging surface 10. Depending on the length of the middle portion 154, some or the entirety of the tapered portion 202 may also enter into the hanging surface 10.

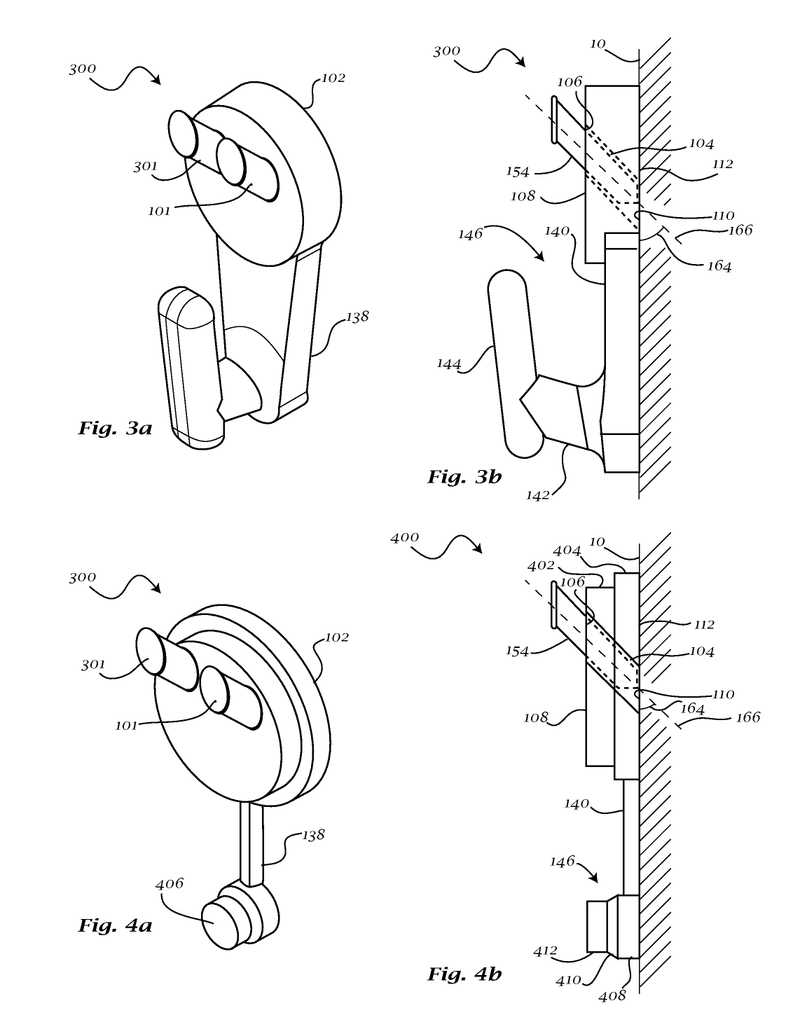

Referring now to exemplary FIGS. 3a and 3b, views of an exemplary embodiment of a wall hanger assembly 300 may be shown. FIG. 3a may show a front isometric view of wall hanger 300 before an external force detaches first needle 101 and a second needle 301 from body 102, and needles 101 and 301 enter into the hanging surface 10. FIG. 3b may show a side view of wall hanger 300 before an external force detaches first needle 101 and a second needle 301 from body 102, and needles 101 and 301 enter into the hanging surface 10. In this exemplary embodiment, the wall hanger assembly 300 may include at least the first hanger body 102 with the first bore 104 and at least a second bore. The first bore 104 can extend from the outer end 106 at the front 108, through the hanger body 102, and to the open inner end 110 at the back 112. Similarly, the second bore can extend from a second outer end at the front 108, through the hanger body 102, and to an open second inner end at the back 112. The first bore 104 may have cross sectional dimensions complementary to the middle portion 154 of needle 101. The second bore may have cross sectional dimensions complementary to the middle portion of the second needle 301. The first bore 104 and the second bore may be spaced clear of the center of the front 108. The bores may be spaced away from the center of the front 108 by equal distances. The second bore and second needle 301 may be dimensionally identical to first bore 104 and first needle 101.

As shown in exemplary FIGS. 3a and 3b, the hanger body 102 may substantially cylinder shaped with the front 108 and back 112 spaced apart and parallel such that the front 108 and back 112 may both be substantially parallel to a hanging surface 10 when the hanger body 102 is nailed to the hanging surface 10. As shown in exemplary FIG. 3b, an entering angle 164 between a lengthwise plane 166 of the first bore 104 and second bore and the hanging surface 10 when the needles 101 and 301 are nailed into the hanging surface 10 may be acute, for example the entering angle 164 may be 60 degrees or 45 degrees.

As shown in exemplary FIGS. 3a and 3b, the hanger body 102 may have a lower hanging element, such as a hook 138. The wall hanger assembly 300 may be molded such that the hook 138 extends from the bottom of hanger body 102. A shank 140 of the hook 138 can seamlessly extend from the back 112 such that the surface area of the hanger body 102 disposed against the hanging surface 10 is maximized. This can allow the wall hanger assembly 300 to hang high-mass objects. When the hanger body 102 is nailed to a hanging surface 10, the shank 140, a bend 142, and a throat 144 of the hook 138 can define a channel 146 for receiving any hanging element, for example a wire or loop, that may be used to suspend an object being supported by the wall hanger assembly 300 in its desired location. The bend 142 may be rounded to reduce friction and long-term tearing imposed on any received hanging element.

Referring now to exemplary FIGS. 4a and 4b, views of an exemplary embodiment of a wall hanger assembly 400 may be shown. FIG. 4a may show a front isometric view of wall hanger 400 before an external force detaches first needle 101 and a second needle 301 from body 102, and needles 101 and 301 enter into the hanging surface 10. FIG. 4b may show a side view of wall hanger 400 before an external force detaches first needle 101 and a second needle 301 from body 102, and needles 101 and 301 enter into the hanging surface 10. In this exemplary embodiment, the hanger body 102 may have a front portion 402 and a back portion 404. Both the front portion 402 and the back portion 404 may be substantially cylinder shaped. The front portion 402 may have a smaller diameter than the back portion 404.

Additionally, the wall hanger assembly 400 may include at least the first hanger body 102 with the first bore 104 and at least a second bore. The first bore 104 can extend from the outer end 106 at the front 108, through the front portion 402 and the back portion 404 of the hanger body 102, and to the open inner end 110 at the back 112. Similarly, the second bore can extend from a second outer end at the front 108, through the front portion 402 and the back portion 404 of the hanger body 102, and to an open second inner end at the back 112. The first bore 104 may have cross sectional dimensions complementary to the middle portion 154 of needle 101. The second bore may have cross sectional dimensions complementary to the middle portion of the second needle 301. The first bore 104 and the second bore may be spaced clear of the center of the front 108. The bores may be spaced away from the center of the front 108 by equal distances. The second bore and second needle 301 may be dimensionally identical to first bore 104 and first needle 101.

As shown in exemplary FIG. 4b, an entering angle 164 between a lengthwise plane 166 of the first bore 104 and second bore and the hanging surface 10 when the needles 101 and 301 are nailed into the hanging surface 10 may be acute, for example the entering angle 164 may be 60 degrees or 45 degrees.

Further referring to FIGS. 4a and 4b, the hanger body 102 may have a lower hanging element, such as a hook 138. The wall hanger assembly 400 may be molded such that the hook 138 extends from the bottom of the hanger body 102. The shank 140 of the hook 138 can seamlessly extend from the back 112. When the hanger body 102 is nailed to a hanging surface 10, the shank 140 and a knob 406 of the hook 138 can define the channel 146 for receiving any hanging element, for example a wire or loop, that may be used to suspend an object being supported by the wall hanger assembly 400 in its desired location. The knob 406 may have a back knob portion 408 to which the bottom of the shank 140 is coupled. The knob 406 may also include a tapered portion 410 and a front knob portion 412, which can specifically define the channel 146.

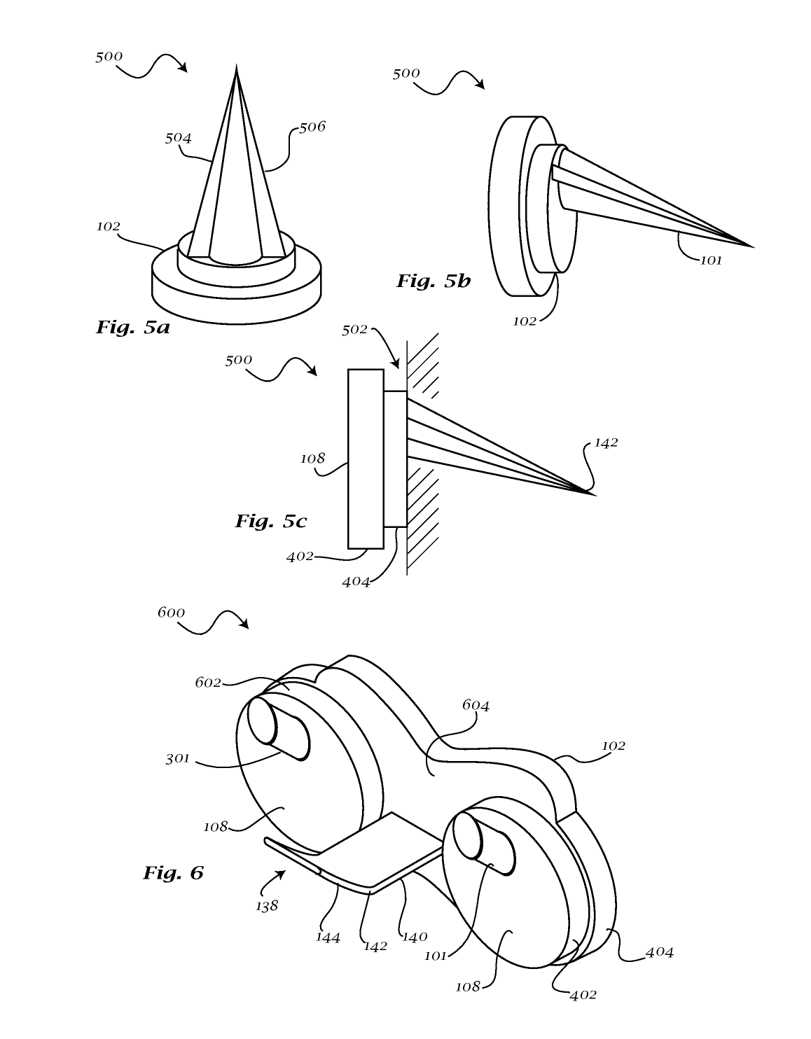

Referring now to exemplary FIGS. 5a, 5b, and 5c, views of an exemplary embodiment of a wall hanger assembly 500 may be shown. FIG. 5a may show a top isometric view of wall hanger 500 before an external force exerted on the front 108 pounds first needle 101 into the hanging surface 10. FIG. 5b may show a side-back isometric view of wall hanger 500 before an external force exerted on the front 108 pounds first needle 101 into the hanging surface 10. FIG. 5c may show a side view of wall hanger 500 after an external force exerted on the front 108 pounds needle 101 into the hanging surface 10. In this exemplary embodiment, the wall hanger assembly 500 may include at least the first hanger body 102. The hanger body 102 may have a front portion 402 and a back portion 404. Both the front portion 402 and the back portion 404 may be substantially cylinder shaped. The front portion 402 may have a larger diameter than the back portion 404. As shown in FIG. 5c, the front portion 402, the back portion 404 and the hanging surface 10 can define the channel 502 for receiving any hanging element, for example a wire or loop, that may be used to suspend an object being supported by the wall hanger assembly 500 in its desired location.

As shown in exemplary FIGS. 5a-c, the needle 101 may be conically tapered from the back 112 of the hanger body 102 to the point 142 of the needle 101. Additionally, the needle 101 may have a left fin 504 and a right fin 506 that increase the contact surface area between the fastening element and the holding area of the wall. The fins 504, 506 may run along the sides of the needle 101 and likewise taper to the point 142.

Referring now to exemplary FIG. 6, views of an exemplary embodiment of a wall hanger assembly 600 may be shown. FIG. 6 may show a front isometric view of wall hanger 600 before an external force detaches first needle 101 and a second needle 301 from body 102, and needles 101 and 301 enter into a hanging surface. In this exemplary embodiment, the hanger body 102 may have a first front portion 402, a second front portion 602, and a back portion 404. Both the first front portion 402 and the second front portion 602 may be substantially cylinder shaped. The back portion 404 may be shaped as a flat irregularly curved prism. The entirety of the perimeters of the first front portion 402 and the second front portion 602 can fit within the perimeter of the back portion 402. The first front portion 402 and the second front portion 602 may be spaced clear of the center of a front face 604 of the back portion 404. The first front portion 402 and the second front portion 602 may be spaced away from the center of the front face 604 of the back portion 404 by equal distances. The second bore and second needle 301 may be dimensionally identical to first bore 104 and first needle 101.

Additionally, the wall hanger assembly 600 may include the first hanger body 102 with the first bore and at least a second bore. The first bore can extend from the outer end at the front 108, through the first front portion 402 and the back portion 404 of the hanger body 102, and to the open inner end at the back of the hanger body 102. Similarly, the second bore can extend from a second outer end at the front 108, through the second front portion 602 and the back portion 404 of the hanger body 102, and to an open second inner end at the back of the hanger body 102. The first bore may have cross sectional dimensions complementary to the middle of needle 101. The second bore may have cross sectional dimensions complementary to the middle portion of the second needle 301. The bores may be spaced away from the center of the front 108 by equal distances. The second front portion 602, second bore and second needle 301 may be dimensionally identical to the first front portion 402, first bore, and first needle 101.

Further referring to FIG. 6, the hanger body 102 may have a lower hanging element, such as a hook 138. The wall hanger assembly 600 may be molded such that the hook 138 can extend substantially outward from the front face 604 of the back portion 404 of the hanger body 102. The shank 140 of the hook 138 may be substantially perpendicular to the front face 604. When the hanger body 102 is nailed to a hanging surface 10, the shank 140, bend 142, and throat 144 of the hook 138 can define a channel for receiving any hanging element, for example a wire or loop, that may be used to suspend an object being supported by the wall hanger assembly 600 in its desired location.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A wall hanger apparatus, comprising:
at least a first hanger body having at least a first lower hanging element, at least a first bore that has cross sectional dimensions complementary to a middle portion; and
at least a first fastening element with a first needle that has at least a head, a shaft, and a point, wherein the shaft has at least a middle portion and a front end, the first hanger body and the first fastening element being an autonomous assembly;
wherein the shaft is forcibly detachable from an outer end of the first bore by an external force is exerted on an outer face of the head when a back of the hanger body is positioned adjacent to a hanging surface, and wherein the middle portion of the first needle slideably and frictionally enters the first bore until an under face of the head is adjacent to a portion of a front of the hanger body, and the point and the front end to puncture and enter into the hanging surface.

2. The wall hanger apparatus of claim 1, wherein the shaft further comprises a tapered portion between the middle and the front end.

3. The wall hanger apparatus of claim 2 further comprising a joining layer, forcibly detachable by the external force, which joins the shaft and the outer end of the first bore.

4. The wall hanging apparatus of claim 3, wherein an entering angle between a lengthwise plane of the first bore and the hanging surface when the first needle is forced into the hanging surface is acute.

5. The wall hanging apparatus of claim 4, wherein the entering angle is about 45 degrees.

6. The wall hanging apparatus of claim 4, wherein the entering angle is about 60 degrees.

7. The wall hanging apparatus of claim 4, wherein the first bore is angled through the hanger body such that the lengthwise plane of the first bore is perpendicular to an upper face of the front.

8. The wall hanger apparatus of claim 1, further comprising at least a second fastening element, wherein the first hanger body and the first fastening element and the second fastening element are an autonomous assembly.

9. The wall hanger apparatus of claim 8, wherein the second fastening element is identical to the first needle having a head, a shaft, and a point.

10. The wall hanger apparatus of claim 1, wherein the lower hanging element is a hook that defines a channel for receiving a hanging element, such as a wire or loop, which is used to suspend an object from the wall hanger that has been installed on a hanging surface.

11. The wall hanger apparatus of claim 1, wherein the first hanger body and the first fastening element are the same color.

12. The wall hanger apparatus of claim 1, wherein the color of the first hanger body and the first fastening element is the same as a hanging surface to which the wall hanger is to be fastened.

13. The wall hanger apparatus of claim 1, wherein the fastening element is a needle that is conically tapered from a back of the hanger body to a point and includes a right fin and a left fin.

14. A method for installing a wall hanger onto a hanging surface comprising:
positioning a back of a hanger body of a wall hanger adjacent to a hanging surface;
exerting an external force onto an outer face of a head of at least a first needle of the wall hanger;
detaching a shaft of the first needle from an outer end of at least a first bore of the hanger body of the wall hanger;
entering, slideably and frictionally, the first needle into the first bore until an under face of the head is adjacent to a portion of a front of the hanger body;
puncturing the hanging surface with a point of the first needle; and
entering the point and a front end of the first needle into the hanging surface.

15. The method of claim 14, further comprising:
exerting a second external force onto a second outer face of a second head of at least a second needle of the wall hanger;
detaching a second shaft of the second needle from an second outer end of at least a second bore of the hanger body of the wall hanger;
entering, slideably and frictionally, the second needle into the second bore until a second under face of the second head is adjacent to a second portion of the front of the hanger body;
puncturing the hanging surface with a second point of the second needle; and
entering the second point and a second front end of the second needle into the hanging surface.
